(19) United States
(12) Patent Application Publication
(10) Pub. No.: US 2013/0325987 A1
(43) Pub. Date: Dec. 5, 2013

(54) METHOD AND APPARATUS FOR PROVIDING SCHEDULING SERVICE BASED ON MOBILE MESSAGING APPLICATION

(71) Applicant: NHN Corporation, Seongnam-si (KR)

(72) Inventors: Jungmin LEE, Seongnam-si (KR); Hyun Joo Na, Seongnam-si (KR)

(21) Appl. No.: 13/906,972

(22) Filed: May 31, 2013

(30) Foreign Application Priority Data
Jun. 5, 2012 (KR) 10-2012-0060514

(51) Int. Cl. H04L 12/58

(52) U.S. Cl. CPC H04L 51/046
USPC 709/206

(57) ABSTRACT

Provided are a method and an apparatus for providing a scheduling service based on a mobile messaging application. The method for providing the scheduling service includes, in an electronic device including a messaging application, the messaging application generating schedule information by receiving at least one of a candidate time and a candidate location for an event and receiving a selection of a user to be invited to the event among users registered in the messaging application, and transmitting the schedule information to the invited user so that the invited user votes on at least one of a possible time and a possible location for attending the event.

### CROSS-REFERENCE TO RELATED APPLICATION

This application claims priority from and the benefit of Korean Patent Application No. 10-2012-0060514, filed on Jun. 5, 2012, which is hereby incorporated by reference for all purposes as if fully set forth herein.

### BACKGROUND OF THE INVENTION

1. Field of the Invention

Exemplary embodiments of the present invention relate to a method and an apparatus for providing a scheduling service for a mobile messaging application, which scheduling service is based on a messaging application installed in a mobile terminal.

2. Discussion of the Background

A messaging application, which is generally installed in a mobile terminal, such as, a smartphone, is a program for transmitting and receiving a message. The messaging application transmits a user input message or displays a message received from another user, thereby enabling smooth communications between the users.

Conventionally, to schedule an event, such as, a school reunion and a meeting, phone calls are made to invited guests using a mobile terminal, a wired telephone, or chatting using a messaging application.

However, when a schedule is set through phone calls, it is necessary to call each guest individually, causing an inconvenience in terms of adjusting the schedule among a plurality of users and a high cost. When a schedule is set using the messaging application, it takes a great amount of time to adjust the schedule due to time required for inputting messages.

Thus, there is a demand for a method for users to conveniently adjust a schedule.

### SUMMARY OF THE INVENTION

Exemplary embodiments of the present invention provide a method and an apparatus for providing a scheduling service based on a mobile messaging application. The method and the apparatus are capable of conveniently adjusting a schedule of an event with users to participate in the event.

Additional features of the invention will be set forth in the description which follows, and in part will be apparent from the description, or may be learned by practice of the invention.

Exemplary embodiments of the present invention disclose a method of providing a scheduling service implemented by a computer, the method including: generating, in a messaging application, schedule information by receiving at least one of a candidate time and a candidate location for an event, and receiving a selection of users to be invited to the event from users registered in the messaging application; and transmitting the schedule information to the invited users to vote on at least one of a possible time and a possible location for attending the event.

Exemplary embodiments of the present invention disclose a non-transitory computer-readable storage media having stored thereon a computer program that, when executed by an electronic device including a display, one or more processors and a messaging application, causes the one or more processors to perform acts that provide a scheduling service, the acts including: generating, in a messaging application, schedule information by receiving at least one of a candidate time and a candidate location for an event, and receiving a selection of users to be invited to the event from users registered in the messaging application; and transmitting the schedule information to the invited users to vote on at least one of a possible time and a possible location for attending the event.

Exemplary embodiments of the present invention disclose an electronic device including: a display; a processor; a memory; and a program stored in the memory and executable by the processor, wherein the program is configured to generate a schedule information by receiving at least one of a candidate time and a candidate location for an event and receiving a selection of users to be invited to the event among users registered in a messaging application through the messaging application stored in the memory, configured to transmit the schedule information to an invited user's electronic device, wherein the schedule information is used to vote on at least one of a possible time and a possible location for attending the event, and configured to display the schedule information on the display.

Exemplary embodiments of the present invention disclose a method of providing a scheduling service implemented by a computer, the method including: receiving schedule information for an event from an electronic device including a messaging application; and transmitting the received schedule information to an electronic device of an invited user to vote on at least one of a possible time and a possible location to attend the event, wherein the schedule information is generated by the messaging application receiving at least one of a candidate time and a candidate location for the event and receiving a selection of users to be invited to the event from the users registered in the messaging application.

Exemplary embodiments of the present invention disclose a scheduling server including: a reception unit configured for receiving schedule information about an event from an electronic device including a messaging application; and a transmission unit configured for transmitting the received schedule information to an electronic device of an invited user to vote on at least one of a possible time and a possible location to attend the event, wherein the schedule information is generated by the messaging application receiving at least one of a candidate time and a candidate location for the event and receiving a selection of the invited user from the users registered in the messaging application.

It is to be understood that both the foregoing general description and the following detailed description are exemplary and explanatory and are intended to provide further explanation of the invention as claimed.

According to exemplary embodiments of the present teachings a user inputs candidate times and candidate locations for an event using the messaging application, and selects users invited to the event among users registered in the messaging application to vote on at least one of a possible time and a possible location for the invited users to attend the event, thereby conveniently adjusting a schedule with the invited users to attend the event when determining the schedule of the event.

A vote reminder message may be transmitted to a user neglecting to vote or confirmed schedule information may be transmitted when a schedule is confirmed through conducting a poll, a schedule may be determined conveniently.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a method of providing a scheduling service based on a mobile application according to exemplary embodiments of the present invention.

FIG. 2 illustrates a method of providing a scheduling service on a scheduling server using a messaging application according to exemplary embodiments of the present invention.

FIG. 3 illustrates an electronic device providing a scheduling service via a scheduling server according to exemplary embodiments of the present invention.

FIG. 4 illustrates a process of providing a scheduling service according to exemplary embodiments of the present invention.

FIGS. 5 to 18 illustrate screens presented on a display when a scheduling service is provided through a messaging application according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Hereinafter, exemplary embodiments of the present invention will be described in detail with reference to the accompanying drawings.

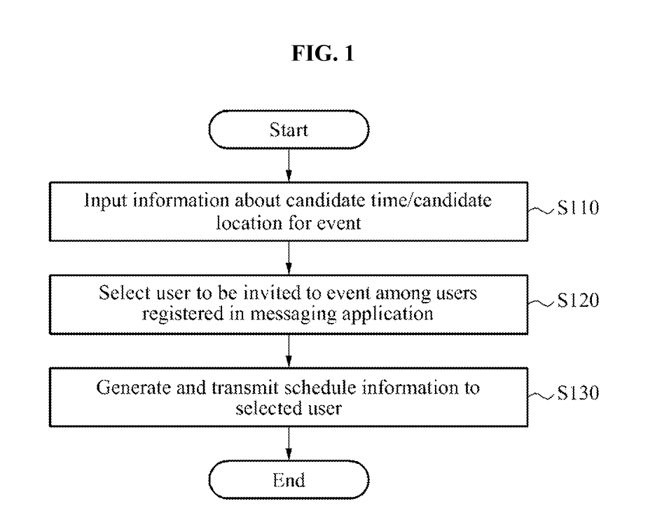

FIG. 1 illustrates a method of providing a scheduling service based on a mobile application according to exemplary embodiments of the present invention. The method of providing the scheduling service may be implemented based on a messaging application included in an electronic device, such as, a smartphone, a tablet, a personal computer (PC) or a tablet PC. The electronic device can be portable.

In step S110, an input of information on at least one of a candidate time and a candidate location for an event is received. A messaging application can receive the input from a user. The messaging application may receive a list of users to be invited to the event. The users to be invited can be selected from users registered in the messaging application in step S120.

The schedule information may include name of the event, description of the event, the at least one candidate time, the at least one candidate location, and the invited user(s). The information about the candidate location may include a description of the candidate location, locale information about the candidate location, and an image related to the candidate location.

In step S130, schedule information can be generated based on the input and the selection of a user. Then the messaging application transmits the schedule information to the invited user(s) to vote. The invited user(s) can vote on at least one of a possible time and a possible location for the selected/invited user to attend the event. In some embodiments, the transmission to the invited user(s) is relayed through a server.

The messaging application may receive polling information from each invited user when the invited user verifies a possibility of attending the event with respect to the candidate times and the candidate locations included in the schedule information. The polling information includes at least one possibility of attending the event selected from attending, maybe attending, and not attending, with respect to at least one of the candidate times and the candidate locations for the event.

When the polling information is not received from the invited user, the messaging application may transmit a vote reminder message to encourage the invited user to vote. The vote reminder can be limited to the invited users on the schedule who have neglected to vote.

When the event scheduling user changes the schedule, for example, due to cancellation or adjusting of the event, the messaging application may transmit a schedule cancellation message to cancel the schedule information of the event to an electronic device of each user, thereby ending the vote and cancelling the schedule. The messaging application may also transmit a schedule change message to change the schedule information of the event to an electronic device of each user, thereby resetting the vote for the schedule. In some embodiments, a change to the schedule may include cancelling the originally scheduled event and adding a new event with the changed information.

When an invited user confirms the schedule of the event based on the polling information, the messaging application may transmit confirmed schedule information. In some embodiments, the messaging application can provide automatic confirmation of the event once all votes have been received. The confirmed schedule information provides the confirmed schedule to each user, thereby informing users invited to the event of the confirmed schedule.

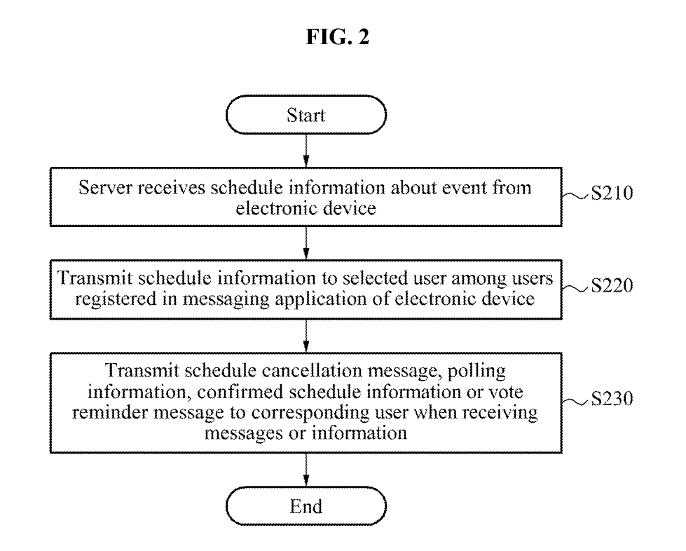

FIG. 2 illustrates a method of providing a scheduling service on a scheduling server using a messaging application according to exemplary embodiments of the present invention.

In some embodiments, the messaging application included in the electronic device provides a scheduling service by transmitting the schedule information to a scheduling server. When the scheduling server receives schedule information for an event from an electronic device at S210, the scheduling server transmits the received scheduling information to an electronic device of an invited user in step S220. The schedule information may be generated by the messaging application receiving input of information about at least one of a candidate time and a candidate location for the event from an event scheduler or user, and receiving a selection of users to be invited to the event from the users registered in the messaging application.

When the user receiving the schedule information verifies a possibility of attending the event with respect to the candidate times and the candidate locations included in is the schedule information, the scheduling server receives polling information from the electronic device of the invited user and transmits the polling information to an electronic device of the event scheduler.

When the event scheduler cancels the event, the scheduling server may receive a schedule cancellation message to cancel the schedule information about the event from the electronic device of the event scheduler and transmit the schedule cancellation message to an electronic device of each invited user.

When the schedule of the event is confirmed based on the polling information, the scheduling server may receive confirmed schedule information from the electronic device of the event scheduler and transmit the confirmed schedule information to the electronic device of each invited user.

When a vote reminder message is received from the electronic device of the event scheduler, the scheduling server may transmit the vote reminder message to an electronic device of a user neglecting to vote.

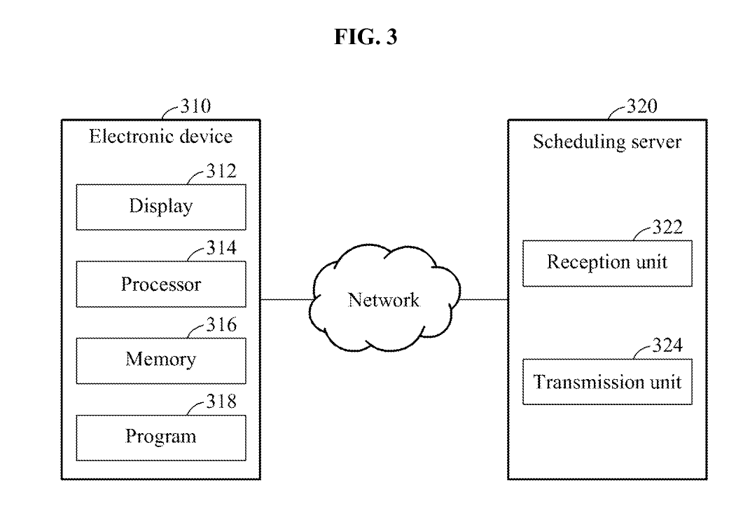

FIG. 3 illustrates an electronic device providing a scheduling service via a scheduling server according to an exemplary embodiment of the present invention. The electronic device 310 includes a display 312, a processor 314, a memory 316, and a program 318 stored in the memory 316 and executed by the processor 314.

The program 318 may generate schedule information by receiving at least one of a candidate time and a candidate location for an event and receiving a selection of a user to be invited to the event among users registered in a messaging application stored in the memory 316 through a messaging application. The program 318 may transmit the schedule information to the invited user through a network. The invited user can vote on at least one of a possible time and a possible location for the invited user to attend the event. The program 318 includes an instruction to display the schedule information on the display 312.

The program 318 may transmit a schedule cancellation message to cancel the event through the network. The program 318 may receive polling information with respect to at least one of the candidate time and the candidate location for the event.

When a schedule of the event is confirmed based on the polling information, the program 318 may transmit confirmed schedule information to the invited user through the network. When the polling information fails to be received from one or more invited user, the program 318 may transmit a vote reminder message to encourage an invited user who has not voted to vote. In some embodiments, program 318 can include a messaging application. In some embodiments, program 318 can include a program capable of interfacing with a messaging application executing on the electronic device.

The scheduling server 320 may include a reception unit 322 and a transmission unit 324. The reception unit 322 receives the schedule information on the event from the electronic device including the messaging application through the network. The transmission unit 324 transmits the schedule information received from the reception unit 322 to the electronic device of the invited user to vote on at least one of a possible time and a possible location for attending the event.

The schedule information may be generated by the messaging application receiving at least one of the candidate time and the candidate location for the event and receiving a selection of a user to be invited to the event among the users registered in the messaging application. The schedule information may include a name of the event, a description of the event, a candidate time, a candidate location, and an invited user. The candidate location may include at least one of a description of the candidate location, locale information about the candidate location, and an image related to the candidate location.

When the reception unit 322 receives a schedule cancellation message to cancel the schedule information about the event from the messaging information on the electronic device, the transmission unit 324 may transmit the schedule cancellation message to a corresponding user.

When the reception unit 322 receives polling information from the electronic device of the invited user, the transmission unit 324 may transmit the polling information to the electronic device 310. The polling information can include attending, maybe attending, and not attending, with respect to at least one of the candidate time and the candidate location for the event.

When the schedule of the event is confirmed based on the polling information, the reception unit 322 may receive confirmed schedule information on the confirmed schedule from the messaging application on the electronic device. When the schedule of the event is confirmed based on the polling information, the transmission unit 324 may transmit the confirmed schedule information to the electronic device of the invited user.

When the reception unit 322 receives a vote reminder message to encourage a user to vote on the schedule from the messaging application on the electronic device, the transmission unit 324 may transmit the vote reminder message to an electronic device of the user neglecting to vote.

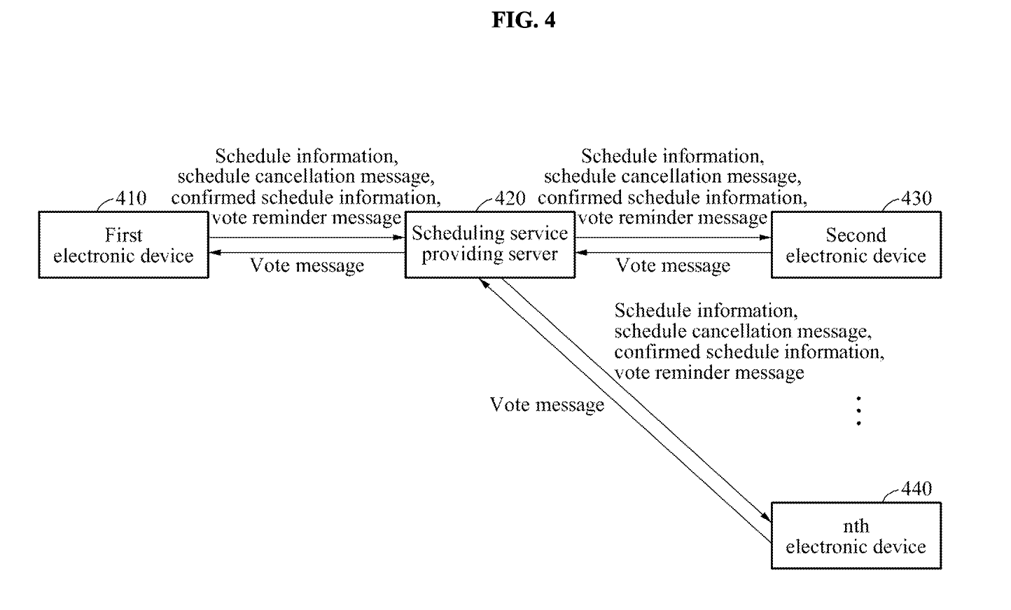

FIG. 4 illustrates a process of providing a scheduling service according to exemplary embodiments of the present invention. The process permits a first user to adjust scheduling of an event with a plurality of users will be described in detail with reference to FIG. 4.

As an example, a first user inputs at least one candidate time and at least one candidate location using a messaging application included in a first electronic device 410 and selects a user to be invited to an event among the users registered in the messaging application. The messaging application then generates schedule information including the at least one candidate time and the at least one candidate location and transmits the schedule information to a scheduling server 420.

When the schedule information is received from the first electronic device 410, a scheduling server 420 transmits the schedule information to one or more electronic devices, for example, a second electronic device 430 through an nth electronic device 440. The electronic devices selected to receive the transmission are based on information about the invited users included in the schedule information.

When a user of the second electronic device 430 receiving the schedule information votes for possible time/location to attend the event among the candidate time and the candidate location, the second electronic device 420 transmits polling information to the scheduling server 420. The scheduling server 420 then transmits the received polling information to the first electronic device 410. In some embodiments, the scheduling server 420 can tally the votes to determine a count for each of the candidate times and locations. In some embodiments, the scheduling server 420 can use the tally to determine which candidate time received the most votes. In some embodiments, the scheduling server can use the tally to determine which candidate location received the most votes. In some embodiments, the confirmed schedule can include at least one of most voted for time, most voted for location, or a combination thereof. In some embodiments, the tallying, the counting and determining of the confirmed schedule as describe above can be performed by an electronic device.

When a user on the first electronic device 410 cancels the schedule while making adjustments to the schedule with though the foregoing process, the messaging application included in the first electronic device 410 transmits a schedule cancellation message to the scheduling server 420. The scheduling server 420 then transmits the cancelling request to the electronic devices of the invited users, thereby canceling the schedule being adjusted. When an invited user neglects to vote on the proposed schedule, the first user may transmit a vote reminder message to the respective electronic devices of the invited user using the messaging application included in the first electronic device 410, thereby encouraging the second user to vote on the proposed schedule.

When the schedule is confirmed, the first user transmits the confirmed schedule information to individual users participating in the event using the messaging application included in the first electronic device 410 through the scheduling server 420.

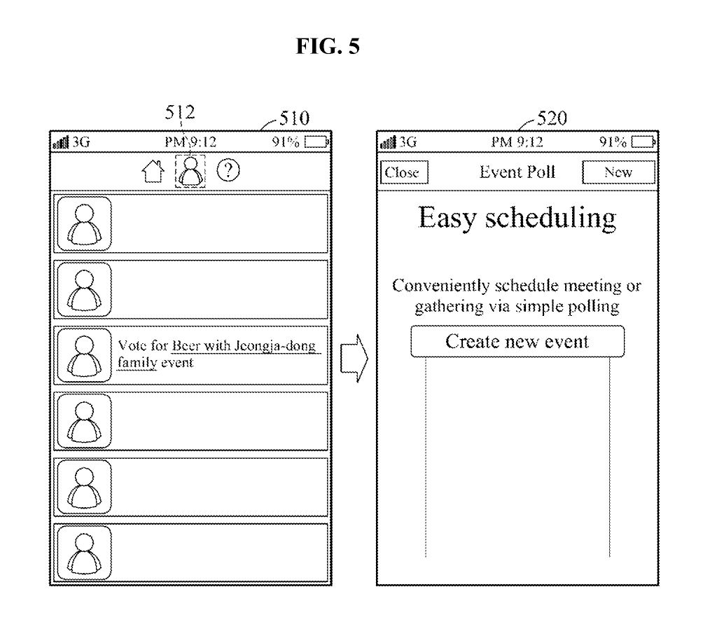

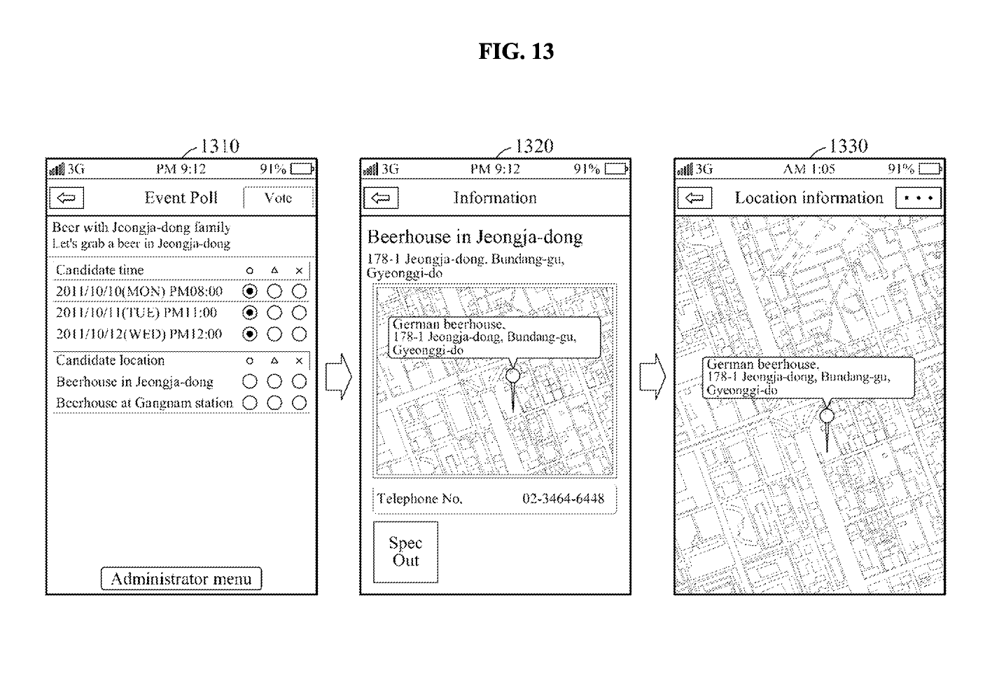

FIGS. 5 to 18 illustrate screens presented on a display of an electronic device when a scheduling service is provided through a messaging application according to an exemplary embodiment of the present invention.

FIG. 5 illustrates a process of accessing a top screen 520 of the scheduling service from a screen 510 displayed on the display of the electronic device through the messaging application. The screen 510 of the messaging application displays information on a schedule being currently adjusted or confirmed. A button 512 for accessing the scheduling service is displayed on an area of the screen 510. When the button 512 is selected, the top screen 520 of the scheduling service is displayed. For example, the top screen 520 of the scheduling service may be displayed when a user creates a schedule or no invitations from other users are present.

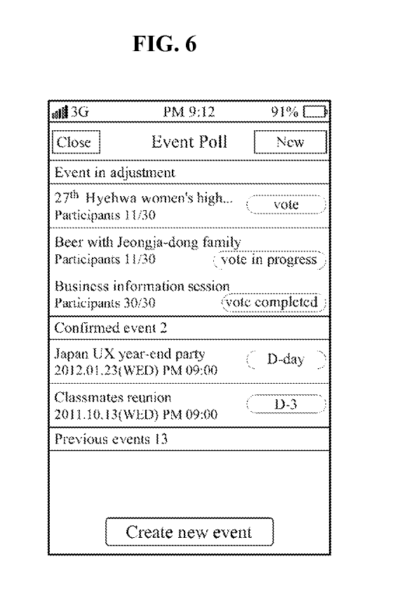

When an invitation from another user is present, a top screen of the scheduling service may be displayed as shown in FIG. 6. In this case, the top screen of the scheduling service may display information about one or more events. An event may be in course of adjustment, a confirmed event and a previous event. The top screen can also display other information about a user's events, for example a number of items of each event, event name, event description and the like, as shown in FIG. 6. Each item of the event being made during the course of adjustments may display status information, such as a vote, voting in progress, voting completed and the like. an item of the confirmed event may display an amount of time remaining until the event is scheduled to take place, an invited participant count, a confirmed attending count, and the like. When a previous event is selected items, such as, a previous event, an event cancelled as a result of voting, a confirmed but cancelled event may be displayed, and the like may be displayed.

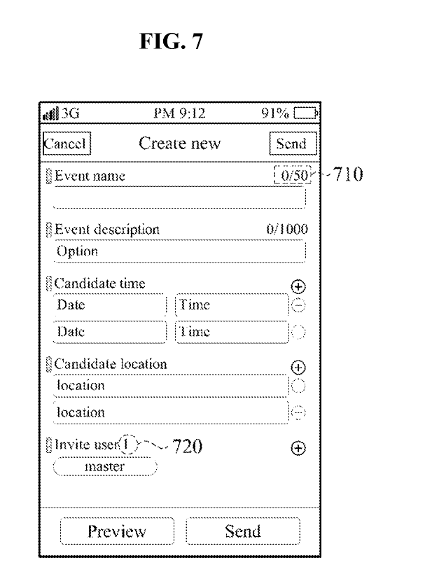

FIG. 7 illustrates a screen displayed when a new event button is selected on the top screen of the scheduling service. When the user selects the new event button on the top screen of the scheduling service, a screen 710 to input an event name, an event description, a candidate time, a candidate location and a list of users to select invitees for an event may be displayed.

Information about a count of currently input characters may be displayed adjacent various text input boxes, for example, the event name, the event description. A section 710 for displaying the input characters count may display the number of currently input characters, counted in real time as the user inputs the event name and the event description.

A section for inputting multiple candidate times and the candidate locations is displayed. The multiple candidate times/locations can be input with a plurality of input sections as shown in FIG. 7.

A count 720 of users currently invited may be displayed. An identification (ID) of a master inviting other users, i.e., event scheduler may be displayed. The master user or event scheduler generating a schedule may be input as a default on an area of an invite user section.

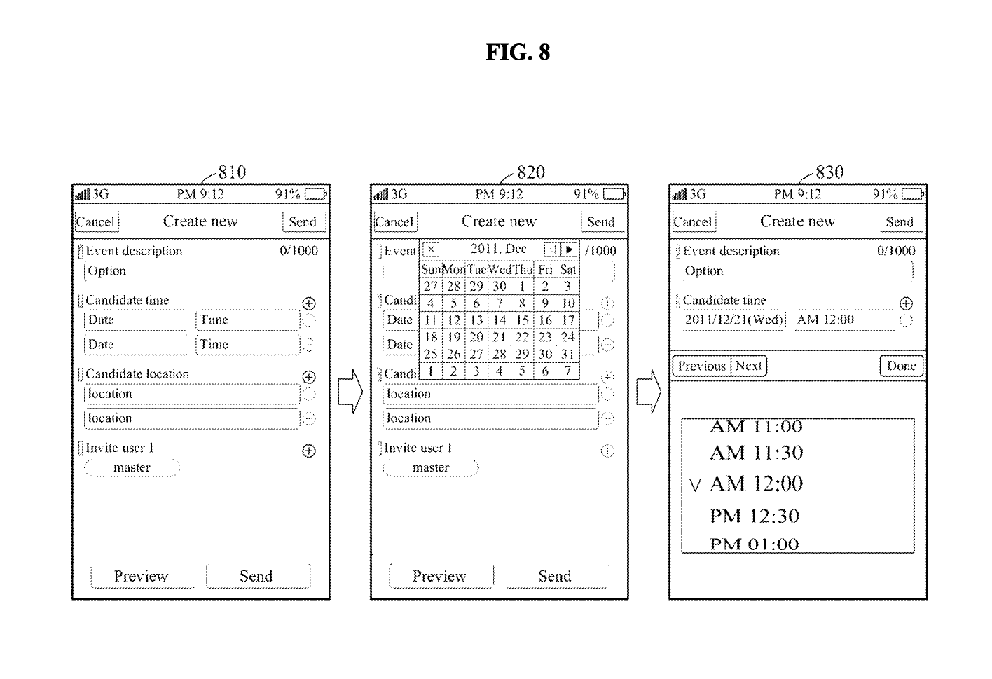

Referring to FIG. 8, when a “+” button displayed in a section for inputting a candidate time is selected on a new event screen 810, a calendar layer 820 for inputting a date may be displayed. When a date is selected on the calendar layer 820, a time controller 830 for inputting a time may be displayed.

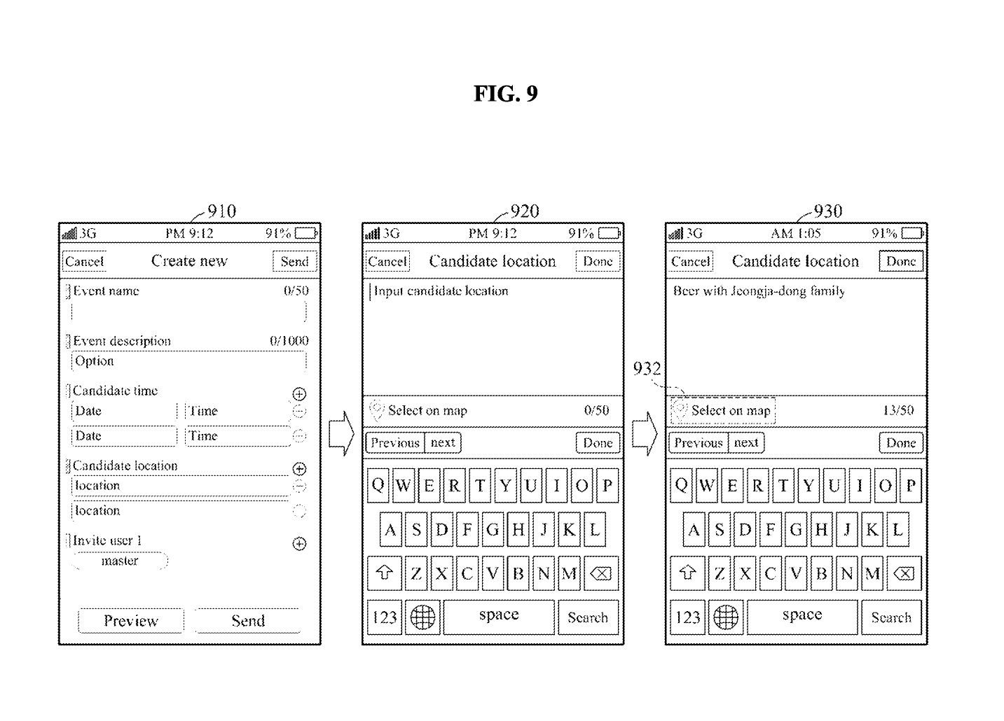

As shown in FIG. 9, when a “+” button displayed in a section for inputting a candidate location is selected on a new event screen 910, a screen 920 for inputting a candidate location is displayed. The user may input details of the candidate location using a keyboard displayed on an area of the screen 920. When the user inputs the candidate location, a number of characters currently input by the user may be displayed on an area of a screen 930 for inputting the candidate location.

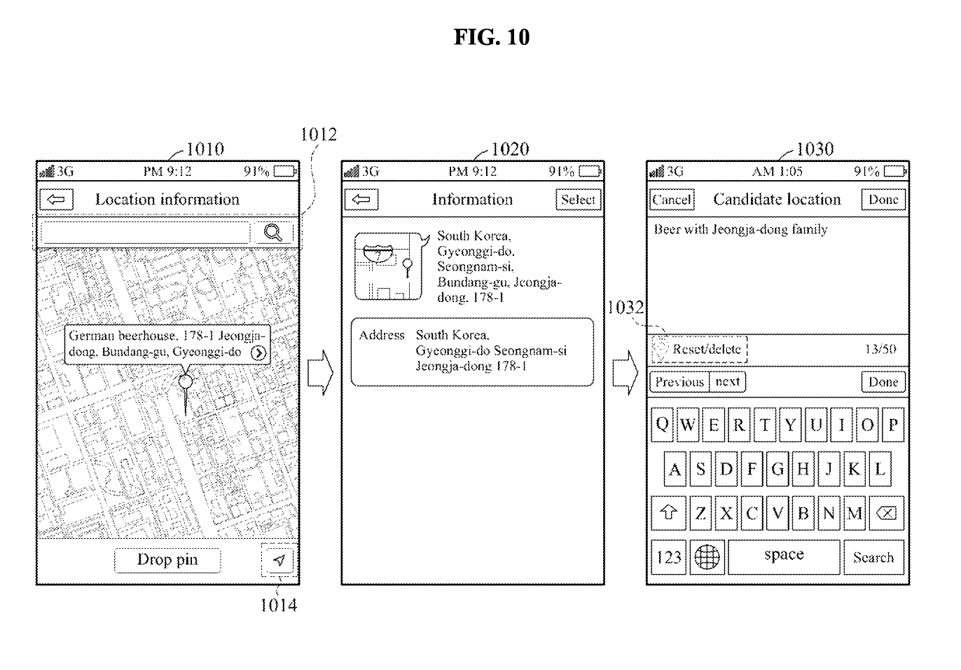

The user may attach location information on the candidate location using a “select on a map” button 932 provided on an area of the screens 920 and 930. When the user selects the “select on a map” button 932, a location information screen 1010 shown in FIG. 10 including information may be displayed for the user to attach the location information including, for example, a map.

Although not shown in FIG. 9, a picture attachment icon may be displayed on an area of the screen 930 to attach an image related to the location.

Referring to FIG. 10, a search box 1012 may be displayed the location information screen 1010 so that the user may input location information, for example, by searching for a location name, a location address, or the like. When the user selects a “drop a pin” button on the location information screen 1010, a pin-dropped location may occupy a center of a map and information about the location may be displayed. Further, when a current position button 1014 is selected, a current position of the user may be displayed on the map.

When the information about the pin-dropped location is selected, an information screen 1020 including detailed information about the location may be displayed. When the location information is attached on a screen 1030 for inputting a candidate location through this process, a color and a shape of the “select on map” button may be displayed in a different format than before the location information is attached to indicate that the location information is attached. In this case, a “reset/delete” button 1032 may be displayed instead of the “select on map” button, enabling the user to reset or delete the attached location information using the button 1032.

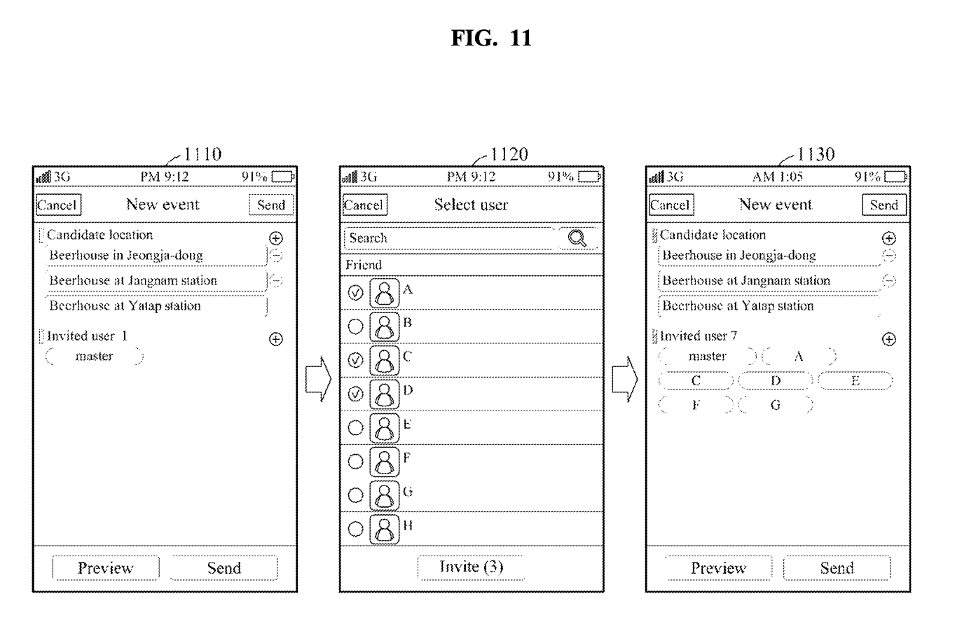

FIG. 11 illustrates that three candidate locations have been input on a new event screen 1110. A location information-attached candidate location may be displayed in a color or an underlined text, such as “Beerhouse in Jeongja-dong,” thereby indicating that location information has been attached, or an icon indicating that location information has been attached may be displayed next to a section for inputting a candidate location.

When a “+” button in an area of an invite user section is selected on the new event screen 1110, a screen 1120 for selecting a user to be invited among users registered in the messaging application may be displayed. When a select button displayed next to each user on the user selection screen 1120 is selected, the select button is checked and a number of users currently selected by the user are counted on an invite button of the user selection screen 1120.

When the invite button is selected on the user selection screen 1120, the number of users invited to a present time and IDs of the users may be displayed on an invite user section of a new event screen 1130.

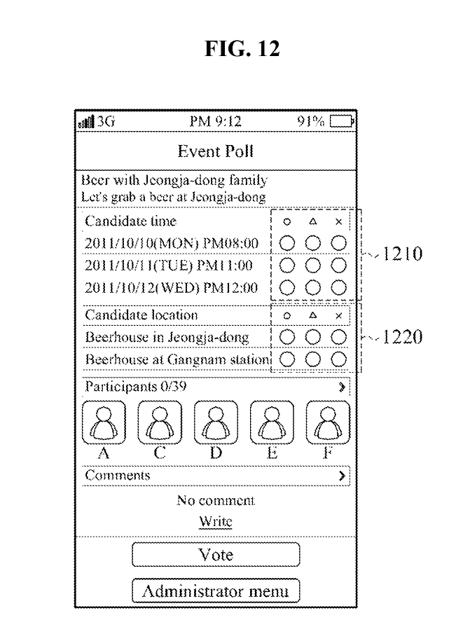

After a candidate time and a candidate location are input and a user to be invited is selected through the foregoing process, a poll screen including schedule information may be displayed as shown in FIG. 12.

A button 1210 enabling the invited user to select at least one of attending, maybe attending, and not attending, with respect to a possible time to attend among candidate times and a button 1220 to verify a possible location for attending an event. As an example, candidate locations may be displayed next to sections in which information about the candidate times and information about the candidate locations are displayed. Further, the number of users invited to the event and the IDs of the users may be displayed in a participating user section. A comment section for a comment input by each user regarding the event may be displayed on an area of the poll screen.

When a user adjusting a schedule (hereinafter, referred to as a “master”) inputs information about a candidate time and a candidate location, and selects a user to be invited to the event, the messaging application generates and transmits schedule information to an electronic device of each user. In some embodiments, the transmission is relayed by and through a scheduling server.

After the schedule information is received, the electronic device of each user informs the user of the schedule information through a push notification service or the like. When the user selects the push notification service or executes the messaging application, a poll screen 1310 including the schedule information may be displayed on a display of the electronic device of the user. The user may select a possible time/location to attend the event among a plurality of candidate times and a plurality of candidate locations.

When location information is attached to a candidate location, the candidate location may be displayed in a different color or a different shape from a candidate location with no location information attached. When the user selects the location information-attached candidate location, an information screen 1320 including detailed information about the candidate location may be displayed on the display of the electronic device. When the location information is selected on the information screen 1320, a location information screen 1330 which displays the location information about the candidate location on a map may be displayed. Thus, the user may identify a candidate location by manipulation, for example, by moving or enlarging the location information screen 1330.

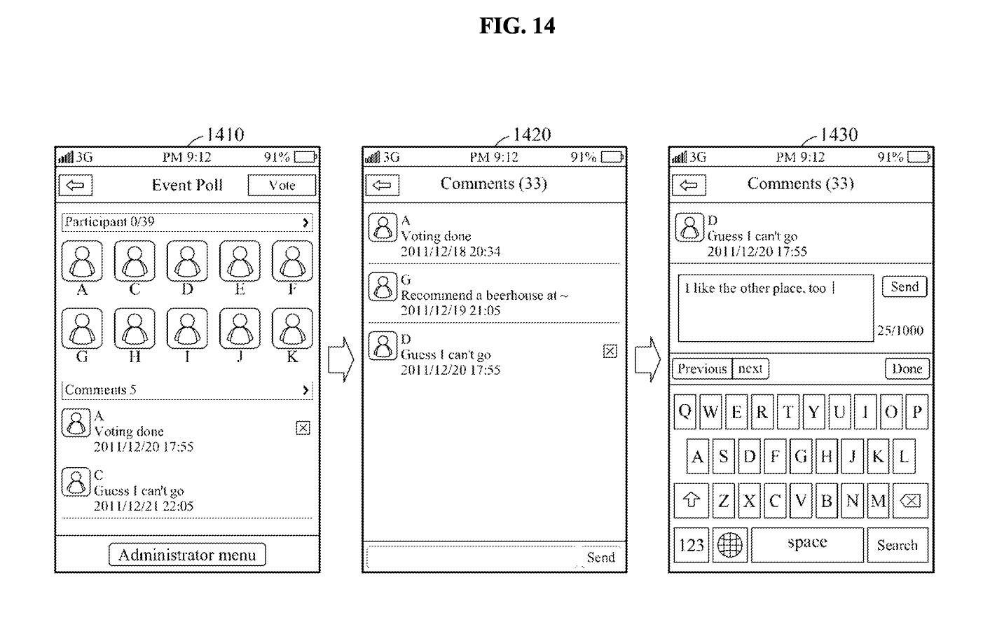

As shown in FIG. 14, information about the user invited to the event and comments input by users may be displayed on a poll screen 1410. When a comment section is selected on the poll screen 1410, a comment input screen 1420 may be displayed. When an input section in an area of the comment input screen 1420 is selected, a keyboard for inputting a text may be displayed. A user may input a comment on the event through a comment input screen 1430 with the keyboard displayed.

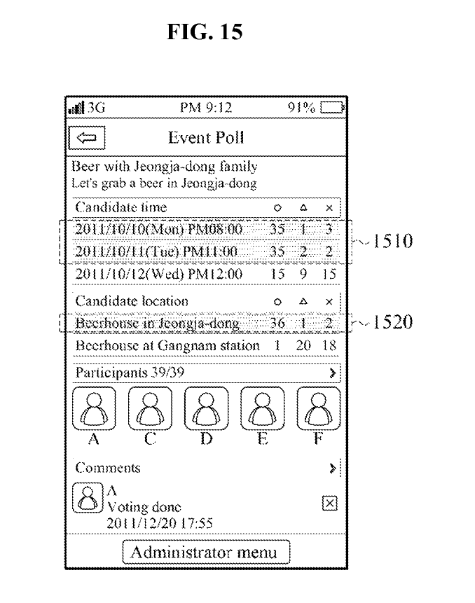

FIG. 15 illustrates a polling screen displayed on the messaging application when a poll on the event is complete. As shown in FIG. 15, results of selection by users are displayed in a section for displaying information about candidate times. Here, a candidate time 1510 possible for the most users may be displayed, for example, in a distinguishing background color on a top of the section. Similarly, a candidate location 1520 possible for the most users may be highlighted, for example, in a distinguishing background color on a top of a section, for displaying candidate locations.

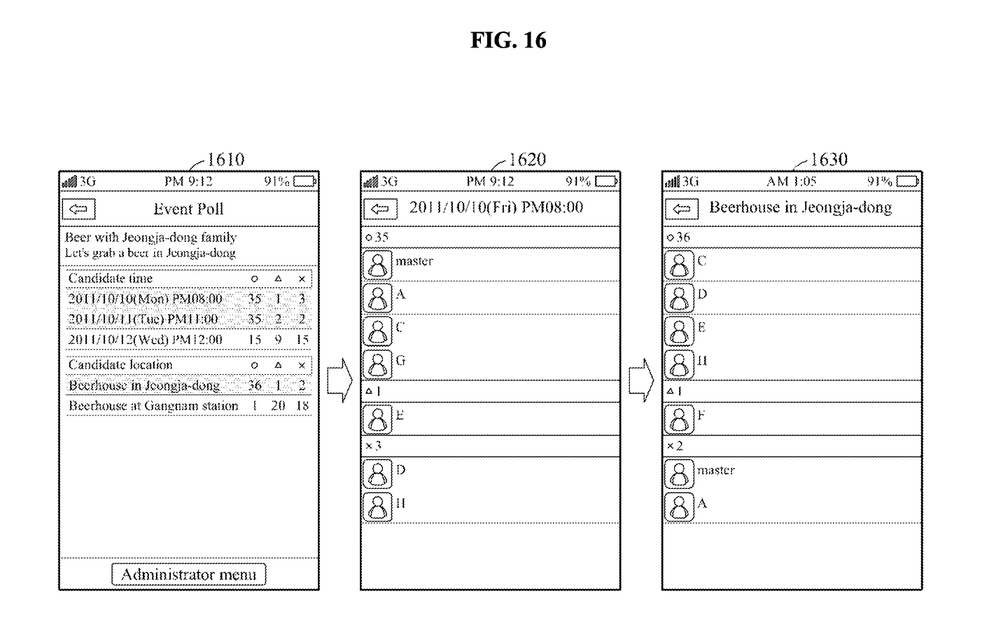

As shown in FIG. 16, when information about one candidate time is selected on a polling screen 1610, a screen 1620 including detailed information about users selecting attending, maybe attending, or not attending with respect to the candidate time may be displayed. When the user selects information about one candidate location on the polling screen 1610, a screen 1630 including detailed information about users checking possible to attend, unsure to attend, or impossible to attend with respect to the candidate location may be displayed.

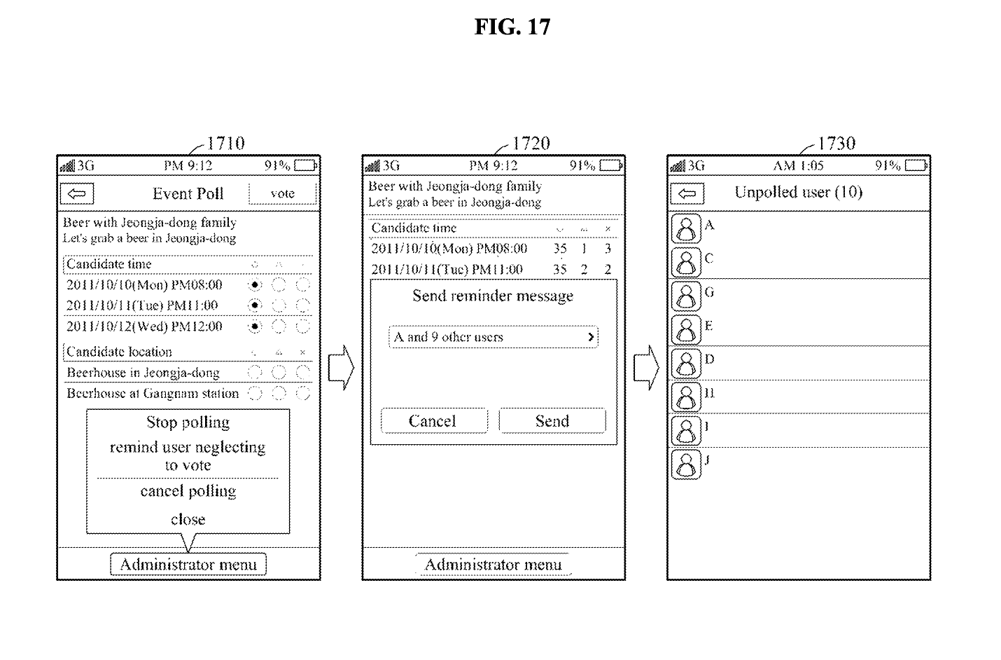

As shown in FIG. 17, an administrator menu button may be displayed in an area of a polling screen 1710. When the master selects the administrator menu button, an administrator menu including “stop polling,” “remind a user neglecting to vote,” and “cancel polling” may be displayed.

When the master selects stop polling, the messaging application may complete a poll on the event and transmit a poll completion message to an electronic device of each user.

When the master selects “remind a user neglecting to vote”, the messaging application may generate and transmit a vote reminder message to a user. a screen 1720 for transmitting the reminder message may be displayed on a display of an electronic device of the master, and information about the user neglecting to vote may be displayed on the screen 1720. When the information about the user neglecting to vote is selected, a screen 1730 including detailed information about the user neglecting to vote may be displayed.

When the master selects cancel polling, the messaging application may generate and transmit a schedule cancellation message about the event to the electronic device of each user.

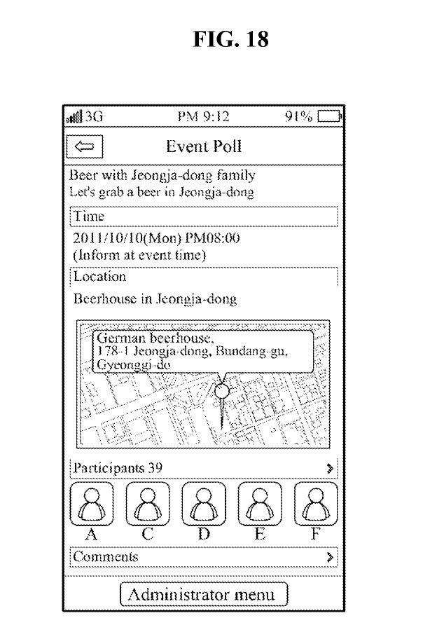

FIG. 18 illustrates a poll completion screen displayed when the master transmits confirmed schedule information. As shown in FIG. 18, the poll completion screen may display an event name, a description of the event, information about a time, information about a location, information about participants, and comments input by users. The confirmed event time displayed on the poll completion screen can, for example, be a candidate time getting most votes for attending and maybe attending. Similarly, the confirmed event location displayed on the poll completion screen can, for example, be a candidate location getting the most votes for attending and maybe attending. In some embodiments, either the proposed event time and/or location can be over-ridden by the master or event scheduler after a tally of votes by the invited users has been done.

A section for displaying the information about the time includes a button for setting a notification, enabling the user to be informed of the event at time desired by a user.

A vote reminder message may be transmitted to a user neglecting to vote or confirmed schedule information may be transmitted when a schedule is confirmed. Through polling, a schedule may be conveniently determined.

Although the method of providing the scheduling service based on the mobile messaging application has been described as an illustrative example, the method of providing the scheduling service according to the present invention may be applied to various user-based platforms, such as a messaging application, a blog, a Social Networking Service (SNS), an address book, and a mail based on a PC, without being limited thereto.

The method of providing the scheduling service according to the present invention may be recorded in computer-readable media including program instructions to implement various operations embodied by a computer. In detail, when the method is implemented by an electronic device including a display, the media may store at least one program including instructions enabling the electronic device to provide the scheduling service.

The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, and vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of providing a scheduling service implemented by a computer, the method comprising:
generating, in a messaging application, schedule information by receiving at least one of a candidate time and a candidate location for an event, and receiving a selection of users to be invited to the event from users registered in the messaging application; and
transmitting the schedule information to the invited users to vote on at least one of a possible time and a possible location for attending the event.

2. The method of claim 1, wherein the schedule information comprises a name of the event, a description of the event, the candidate time, the candidate location, and information about the invited users.

3. The method of claim 1, wherein the candidate location comprises at least one of a description of the candidate location, locale information about the candidate location, and an image related to the candidate location.

4. The method of claim 1, further comprising:
transmitting a schedule cancellation message to cancel the event.

5. The method of claim 1, further comprising:
receiving polling information from the invited users, the polling information comprising an indication of at least one of attending, maybe attending, and not attending the event, with respect to at least one of the candidate time and the candidate location for the event.

6. The method of claim 5, further comprising:
transmitting a confirmed schedule to the invited users, after the receiving, when the schedule of the event is confirmed based on the polling information.

7. The method of claim 5, further comprising:
transmitting a vote reminder message to the invited users from whom polling information has not been received.

8. One or more non-transitory computer-readable storage media having stored thereon a computer program that, when executed by an electronic device comprising a display, one or more processors and a messaging application, causes the one or more processors to perform acts that provide a scheduling service, the acts comprising:
generating, in the messaging application, schedule information by receiving at least one of a candidate time and a candidate location for an event, and receiving a selection of users to be invited to the event from users registered in the messaging application; and
transmitting the schedule information to the invited users to vote on at least one of a possible time and a possible location for attending the event.

9. An electronic device comprising:
a display;
a processor;
a memory; and
a program stored in the memory and executable by the processor,
wherein the program is configured to generate a schedule information by receiving at least one of a candidate time and a candidate location for an event and receiving a selection of users to be invited to the event among users registered in a messaging application through the messaging application stored in the memory,
configured to transmit the schedule information to an invited user's electronic device, wherein the schedule information is used to vote on at least one of a possible time and a possible location for attending the event, and
configured to display the schedule information on the display.

10. The electronic device of claim 9, wherein the schedule information comprises a name of the event, a description of the event, the candidate time, the candidate location, and information about the invited user.

11. The electronic device of claim 9, wherein the candidate location comprises at least one of a description of the candidate location, locale information about the candidate location, and an image related to the candidate location.

12. The electronic device of claim 9, wherein the program is configured to transmit a schedule cancellation message to cancel the event.

13. The electronic device of claim 9, wherein the program is configured to receive polling information from the invited users, the polling information comprising an indication of at least of attending, maybe attending, and not attending the event, with respect to at least one of the candidate time and the candidate location for the event.

14. The electronic device of claim 13, wherein the program is configured to transmit a confirmed schedule to the invited user, after the receiving of the polling information, when the schedule of the event is confirmed based on the polling information.

15. The electronic device of claim 13, wherein the program is configured to transmit a vote reminder message to the invited users from whom the polling information has not been received.

16. A method of providing a scheduling service implemented by a computer, the method comprising:
receiving schedule information for an event from an electronic device comprising a messaging application; and
transmitting the received schedule information to an electronic device of an invited user to vote on at least one of a possible time and a possible location to attend the event,
wherein the schedule information is generated by the messaging application receiving at least one of a candidate time and a candidate location for the event and receiving a selection of users to be invited to the event from the users registered in the messaging application.

17. The method of claim 16, wherein the schedule information comprises a name of the event, a description of the event, the candidate time, the candidate location, and information about the invited user, and the candidate location comprises at least one of a description of the candidate location, locale information about the candidate location, and an image related to the candidate location.

18. The method of claim 16, further comprising receiving a schedule cancellation message to cancel the schedule information of the event from the electronic device and transmitting the schedule cancellation message to the electronic device of the invited user after the transmitting.

19. The method of claim 16, further comprising transmitting polling information to the electronic device when the polling information is received from the electronic device of the invited user, after the transmitting, wherein the polling information comprises an indication of at least one of attending, maybe attending, and not attending with respect to at least one of the candidate time and the candidate location for the event.

20. The method of claim 19, further comprising receiving confirmed schedule information of a confirmed schedule from the electronic device and transmitting the confirmed schedule information to the electronic device of the invited user, when the schedule of the event is confirmed based on the polling information.

21. The method of claim 19, further comprising receiving a vote reminder message to encourage an invited user who has not voted to vote and transmitting the vote reminder message to an electronic device of the invited user.

22. A scheduling server comprising:
a reception unit configured for receiving schedule information for an event from an electronic device comprising a messaging application; and
a transmission unit configured for transmitting the received schedule information to an electronic device of an invited user to vote on at least one of a possible time and a possible location to attend the event,
wherein the schedule information is generated by the messaging application receiving at least one of a candidate time and a candidate location for the event and receiving a selection of the users to be invited to the event from the users registered in the messaging application.

23. The scheduling server of claim 22, wherein the schedule information comprises a name of the event, a description of the event, the candidate time, the candidate location, and information about the invited user, and the candidate location comprises at least one of a description of the candidate location, locale information about the candidate location, and an image related to the candidate location.

24. The scheduling server of claim 22, wherein the scheduling server receives a schedule cancellation message to cancel the schedule information of the event from the electronic device and transmits the schedule cancellation message to the electronic device of the invited user.

25. The scheduling server of claim 22, wherein the scheduling server transmits polling information to the electronic device when the polling information is received from the electronic device of the invited user, the polling information comprises an indication of at least one of attending, maybe attending, and not attending with respect to at least one of the candidate time and the candidate location for the event.

26. The scheduling server of claim 25, wherein the scheduling server receives a confirmed schedule from the electronic device and transmits the confirmed schedule information to the electronic device of the invited user when the schedule of the event is confirmed based on the polling information.

27. The scheduling server of claim 25, wherein the scheduling server receives a vote reminder message to encourage a user to vote, among the invited users neglecting to vote, on the schedule from the electronic device comprising the messaging application and transmits the vote reminder message to an electronic device of the user neglecting to vote.

28. The method of claim 1, wherein the candidate time comprises a plurality of candidate times and the candidate location comprises a plurality of candidate locations.

29. The method of claim 6, wherein an event time in the confirmed schedule comprises the candidate time receiving the most votes in the polling information.

30. The method of claim 6, wherein an event location in the confirmed schedule comprises the candidate location receiving the most votes in the polling information

31. The method of claim 6, wherein the possible time comprises the candidate time, and the possible location comprises the candidate location.
